(19) United States
(12) Patent Application Publication
(10) Pub. No.: US 2007/0053135 A1
(43) Pub. Date: Mar. 8, 2007

(54) System and method for eliminating electrostatic charge in a mailing machine

(75) Inventors: James A. Hough, Monroe, CT (US); Tesfamichiel Feshazion, Orange, CT (US); Eleanor McAuliffe, Stratford, CT (US)

Correspondence Address: PITNEY BOWES INC.;35 WATERVIEW DRIVE, P.O. BOX 3000, MSC 26-22, SHELTON, CT, 06484-8000, US

(73) Assignee: Pitney Bowes Incorporated, Stamford, CT (US)

(21) Appl. No.: 11/209,224

(22) Filed: Aug. 23, 2005

(51) Int. Cl. H02H 1/00

(52) U.S. Cl. 361/212

(57) ABSTRACT

An air ionizer comprises a control circuit and a charge generator circuit. The control circuit is structured to detect an electrostatic charge having a first polarity, and the charge generator circuit is structured to generate a neutralizing charge having a second polarity opposite the first polarity in response to the control circuit detecting the electrostatic charge. The air ionizer may be incorporated into an electronic device such as a mail processing system comprised of a housing having a substantially enclosed area and one or more modules within the housing. A method for eliminating an accumulation of electrostatic charge within an electronic device is also given.

### BACKGROUND

The invention disclosed herein relates generally to mail processing systems, and more particularly to a system and method for automatically eliminating the undesirable effects of electrostatic charge accumulation in a mail processing system.

Mail processing systems, such as, for example, a mailing machine, often include different modules that automate the processes of producing mail pieces. The typical mailing machine includes a variety of different modules or sub-systems each of which performs a different task on the mail piece. The mail piece is conveyed downstream to each of the modules utilizing a transport mechanism, such as rollers or a belt. Such modules could include, for example, a singulating module for separating a stack of mail pieces such that the mail pieces are conveyed one at a time along the transport path, a stripping/moistening module for stripping open the flap of an envelope, and wetting and sealing the glued flap of an envelope, a weighing module for weighing the mail piece, and a metering/printing module for storing postage amounts and applying evidence of postage either directly to the mail piece or to a tape to be applied to the mail piece. The mailing machine is controlled by a central processing unit that executes software stored in memory provided in the mailing machine. The exact configuration of the mailing machine is, of course, particular to the needs of the user.

During the production of mail pieces, unwanted electrostatic charge may be generated within one or more of the different modules or sub-systems. In most mailing machines, management of electrostatic charge depends on the effectiveness of a circuit grounding system and the materials connected thereto. Typical circuit grounding systems, however, do not effectively manage electrostatic charge on fast-moving materials passing over/through a series of non-conductive dissimilar materials (e.g., a paper envelope passing through the rollers and/or over a belt in a module). Accordingly, electrostatic charge may accumulate on the transport path and negatively effect the operation of the mailing machine. For example, the accumulated electrostatic charge may uncontrollably discharge to a grounded element within the mailing machine thereby causing problems such as a component failure, a print head misfire, or a postage loss, among others. Such electrostatic charge related problems are difficult to detect and troubleshoot, often necessitating a user to place a service call to a trained technician.

Additionally, paper dust and/or rubber debris may be generated within one or more of the different modules or sub-systems during mail piece production. The dust and debris typically acquire an electrostatic charge having the same polarity as the material moving through the mailing system (e.g., an envelope). Once charged, the dust and debris are attracted to objects (for example, printing elements, registrations plates, and/or sensors) in the transport path which have a charge with the opposite polarity. Thus, over time the paper dust and rubber debris accumulate on the surfaces of these objects within the transport path. This accumulation causes problems such as performance degradation, loss of print quality, and/or a malfunctioning of the machine, among others, which require a service call to a trained technician.

Thus, there exists a need for a system and method for automatically eliminating the undesirable effects of electrostatic charge accumulation in mail processing systems.

### SUMMARY

One aspect of the present invention relates to a method for eliminating an accumulation of electrostatic charge within an electronic device. The method comprises detecting an electrostatic charge having a first polarity within the electronic device and responsive to the detecting, generating a neutralizing charge having a second polarity opposite of the first polarity within the electronic device.

Another aspect of the present invention relates to an air ionizer which comprises a control circuit structured to detect an electrostatic charge having a first polarity and a charge generator circuit structured to generate a neutralizing charge having a second polarity opposite the first polarity in response to the control circuit detecting the electrostatic charge.

Another aspect of the present invention relates to a mail processing system comprising a housing having a substantially enclosed area, one or more modules within the housing, and an air ionizer. The air ionizer comprises a control circuit structured to detect an electrostatic charge having a first polarity within the substantially enclosed area and a charge generator circuit structured to generate a neutralizing charge having a second polarity opposite the first polarity in response to the control circuit detecting the electrostatic charge.

Therefore, it should now be apparent that the invention substantially achieves all the above aspects and advantages. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### BRIEF DESCRIPTION OF THE DRAWINGS

The accompanying drawings illustrate presently preferred embodiments of the invention, and together with the general description given above and the detailed description given below, serve to explain the principles of the invention. As shown throughout the drawings, like reference numerals designate like or corresponding parts.

FIG. 1 is an isometric view of a mail processing system according to the present invention.

FIG. 2 is a block diagram of the mail processing system of FIG. 1.

FIG. 3 is a block diagram of an air ionizer according to one embodiment.

FIG. 4 is a schematic of a control circuit for the air ionizer of FIG. 3 according to one embodiment.

FIG. 5 is a schematic of a charge generator circuit for the air ionizer of FIG. 3 according to one embodiment.

### DETAILED DESCRIPTION

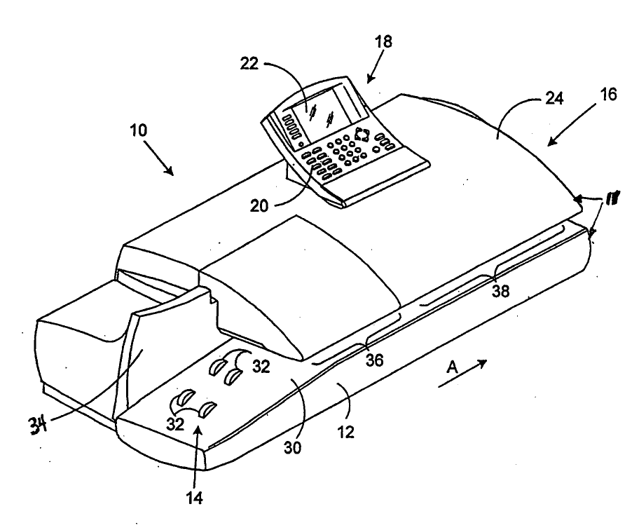

Referring to FIG. 1, an isometric view of a mail processing system 10, such as a mailing machine, according to the present invention is shown. Mail processing system 10 comprises a base unit, designated generally by the reference numeral 12, the base unit 12 having a mail piece input end, designated generally by the reference numeral 14 and a mail piece output end, designated generally by the reference numeral 16. A user interface controller (UIC) 18 is fixedly mounted on the base unit 12, and includes one or more input/output devices, such as, for example, a keyboard 20 and a display device 22. One or more cover members 24 are pivotally mounted on the base 12 so as to move from the closed position shown in FIG. 1 to an open position (not shown) for exposing various operating components and parts for service and/or repair as needed. When closed the one or more cover members 24 form a substantially enclosed area with base unit 12. The base unit 12 and the one or more cover members 24 may generally be referred to as a housing 11.

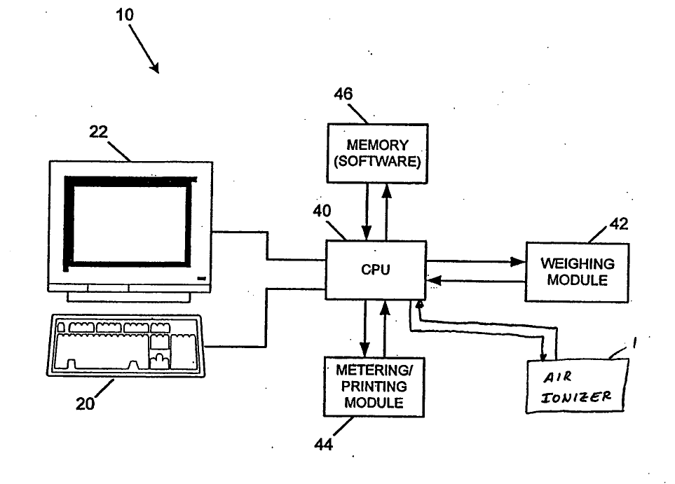

The base unit 12 further includes a horizontal feed deck 30 that extends substantially from the input end 14 to the output end 16. A plurality of nudger rollers 32 are suitably mounted under the feed deck 30 and project upwardly through openings in the feed deck so that the periphery of the rollers 32 is slightly above the upper surface of the feed deck 30 and can exert a forward feeding force on a succession of mail pieces placed in the input end 14. A vertical wall 34 defines a mail piece stacking location from which the mail pieces are fed by the nudger rollers 32 along the feed deck 30 and into a transport system (not shown) that transports the mail pieces in a downstream path of travel, as indicated by arrow A, through one or more modules, such as, for example, a singulating module and stripping/moistening module. Each of these modules is located generally in the area indicated by reference numeral 36. The mail pieces are then passed to a weighing module 42 (shown in FIG. 2) and a metering/printing module 44 (shown in FIG. 2) located generally in the area indicated by reference numeral 38, and exit the mail processing system 10 at the output end 16.

Referring to FIG. 2, mail processing system 10 includes central processing unit (CPU) 40. Display device 22 and keyboard 20 provide a user interface to CPU 40. Weighing module 42, such as a scale, weighs mail pieces and metering/printing module 44, such as postage meter, applies postage to the mail pieces and manages postage amounts stored therein. CPU 40 controls all operations of mail processing system 10 as described herein based on software stored in memory 46, such as a non-volatile memory module. The mail processing system 10 also includes an air ionizer 1 for detecting and eliminating electrostatic charges according to an aspect of the present invention.

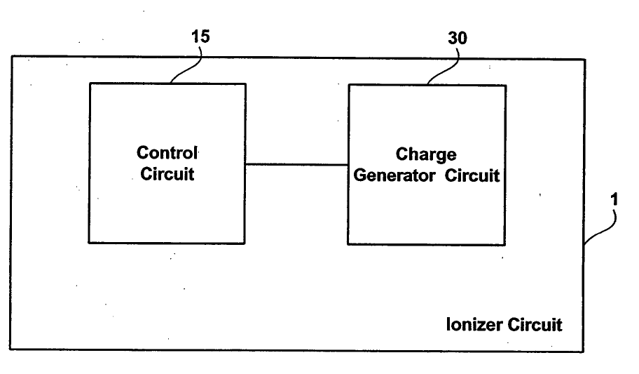

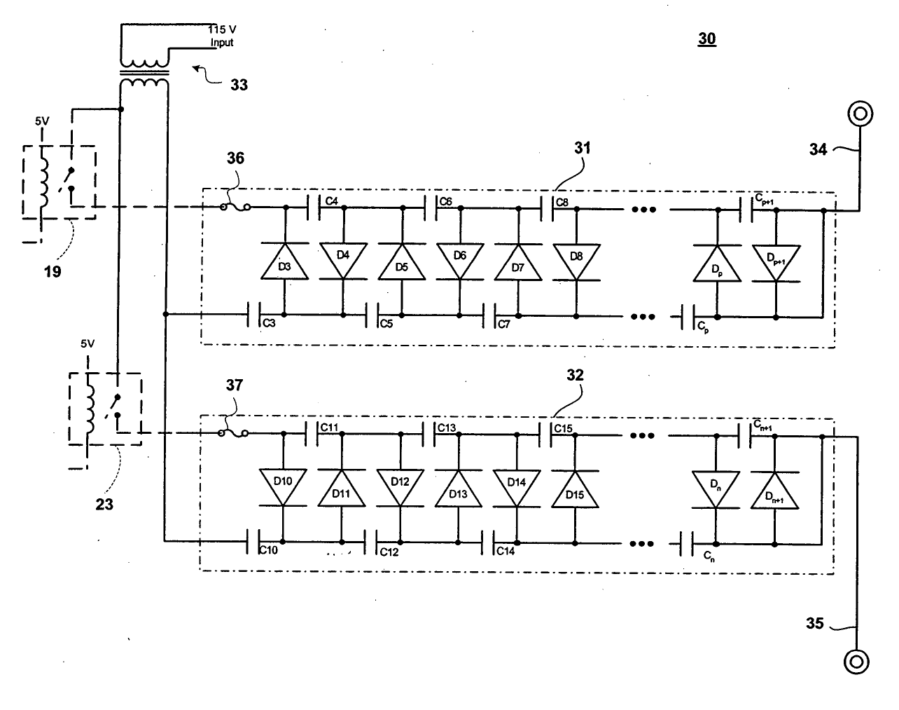

FIG. 3 is a block diagram of an air ionizer 1 according to one embodiment. The air ionizer 1 generally consists of a control circuit 15 and a charge generator circuit 30. The control circuit 15 is structured to detect an electrostatic charge (including the polarity thereof), for example within an enclosed portion of a mail processing system, and is also structured to provide control signals to the charge generator circuit 30. The charge generator circuit 30, responsive to the control signals, generates a neutralizing charge having a polarity opposite of the polarity of the detected electrostatic charge. The neutralizing charge is applied, for example, to an emitter (FIG. 5) which ionizes the surrounding air and neutralizes the detected electrostatic charge within the enclosed portion of the mail processing system. The neutralizing charge may also be applied to a collection device (not shown) which attracts particles carrying the detected electrostatic charge, for example dust and rubber particles within the mail processing system 10. The collection device 10 may be a plate, wire, etc. that is located within the mail processing system 10.

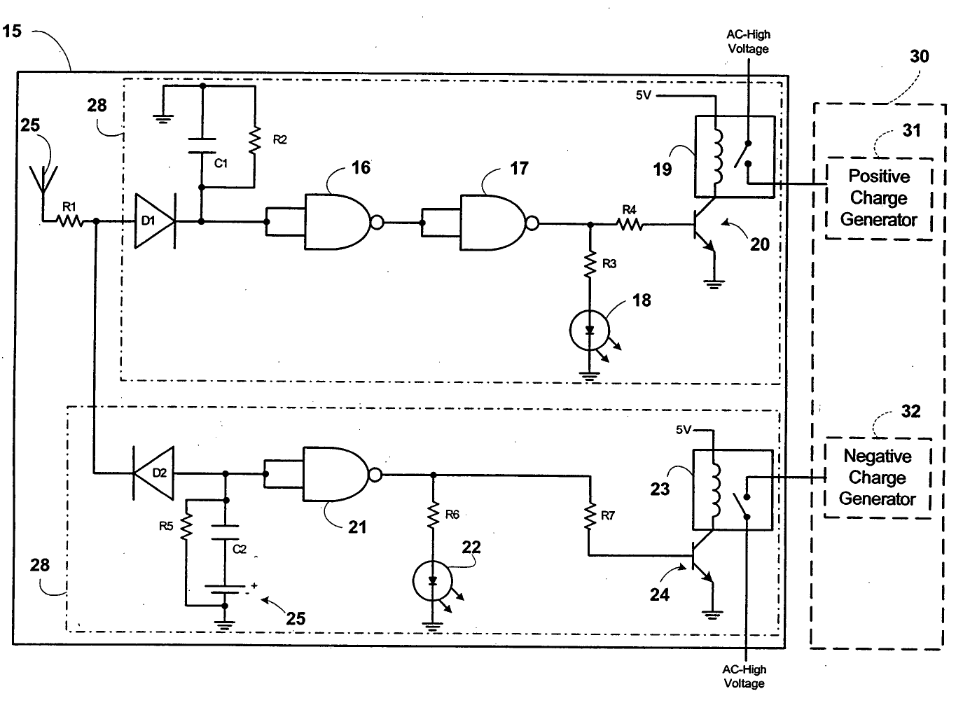

FIG. 4 is a schematic of one embodiment of the control circuit 15 of FIG. 3. The control circuit 15 shown in FIG. 4 is separated into two paths, a first path 27 for sensing and responding to a positive electrostatic charge build up and a second path 28 for sensing and responding to a negative electrostatic charge buildup. In the current example, the control circuit 15 is supplied by a 5 volt power supply, for example, from the MMC board of the mail processing system 10. However, other power source and voltages may be used while remaining within the scope of the present invention.

An antenna 25 serves as a charge-sensing electrode for both the first path 27 and second path 28. Generally the antenna 25 detects the movement of charge, for example, in an enclosed portion of the mail processing system 10. When the antenna 25 detects a charge, a potential develops which is input to the first path 27 and second path 28. A resistor R1 is electrically connected between the antenna 25 and the first path 27 and second path 28 to protect the control circuit 15 from electrostatic discharge.

More specifically, when the antenna 25 detects a positive electrostatic charge, a positive potential develops which is input to the first path 27 and second path 28. This input signal causes diode D1 of the first path 27 to become conductive which, in turn, drives the inputs of NAND gate 16 high (e.g., at logic 1). Under such conditions, the output of NAND gate 16 and thus the inputs of NAND gate 17 are low (e.g., at logic 0). When the inputs of NAND gate 17 are low, the output of NAND gate 17 is high. The signal at the output of NAND gate 17 may be referred to as a first control signal. The first control signal causes an indicator 18 (e.g., an LED) to turn on indicating that a positive electrostatic charge has been detected. Additionally, the first control signal is applied to a switching device 20. In the current example, the switching device 20 is a FET and the first control signal is applied to the gate terminal of the FET. When the first control signal is high, the FET is turned on (i.e., is conductive) causing relay 19 to become energized and thus causing an AC voltage (e.g., from the secondary windings of transformer 33 shown in FIG. 5) to be provided to a positive charge generator circuit 31 within the charge generator circuit 30.

Furthermore, when the antenna 25 detects the positive electrostatic charge, diode D2 of the second path is non-conductive and the inputs of NAND gate 21 are pulled high by a voltage source 25 though capacitor C2 and resistor R5. When the inputs of NAND gate 21 are high, the output of NAND gate 21 is low. The signal at the output of NAND gate 21 may be referred to as a second control signal. The second control signal causes indicator 22 (e.g., an LED) to turn off. Additionally, the second control signal is applied to a switching device 24. In the current example, the switching device is a FET and the second control signal is applied to the gate terminal of the FET. When the second control signal is low, the FET is turned off (i.e., is non-conductive) causing relay 23 to become de-energized, thus isolating the AC voltage from a negative charge generator circuit 32 within the charge generator circuit 30.

In contrast, when the antenna 25 detects a negative electrostatic charge, a negative potential develops which is input to the first path 27 and second path 28. This input signal causes diode D2 of the second path 28 to become conductive which, in turn, drives the inputs of NAND gate 21 low overriding voltage source 25. When the inputs of NAND gate 21 are low, the second control signal (i.e., the signal at the output of NAND gate 21) is high. This causes indicator 22 to turn on indicating that a negative electrostatic charge has been detected. Additionally, the second control signal is applied the switching element 24, in particular to the gate terminal of the FET. When the second control signal is high, the FET is turned on (i.e., is conductive) causing relay 23 to become energized and thus causing an AC voltage (e.g., from the secondary windings of transformer 33 shown in FIG. 5) to be provided to a negative charge generator circuit 32 within the charge generator circuit 30.

Furthermore when the antenna 25 detects the negative electrostatic charge, diode D1 of the first path 27 is non-conductive and the inputs to NAND gate 16 are both pulled low through capacitor C1 and resistor R2. The output of NAND gate 16 and thus the inputs of NAND gate 17 are high. When the inputs of NAND gate 17 are high, the first control signal (i.e., the signal at the output of NAND gate 17) is low, which causes indicator 18 to turn off. Additionally, the first control signal is applied to the switching element 20, in particular to the gate terminal of the FET. When the first control signal goes low, the FET is turned off (i.e., is non-conductive) causing relay 19 to become de-energized, thus isolating the AC voltage from the positive charge generator circuit 31 within the charge generator circuit 30.

FIG. 5 is a schematic of the charge generator circuit 30 of FIG. 3 according to one embodiment. The charge generator circuit 30 shown in FIG. 5 includes the positive charge generator circuit 31, the negative charge generator circuit 32, a transformer 33, a positive charge emitter 34, and a negative charge emitter 35.

In the embodiment shown in FIG. 5, transformer 33 is a matching type transformer with its primary windings electrically connected to a 115 volt AC input. The positive charge generator circuit 31 receives the high-frequency AC voltage supplied from the secondary windings of transformer 33 when relay 19 is energized in the manner described above. The positive charge generator 31 includes a number of diodes (D3, D4, . . . Dₚ₊₁) and a number of capacitors (C3, C4, Cₚ₊₁) which form a multiple stage cascade multiplier for rectifying the high-frequency AC voltage into a positive DC voltage. The positive charge generator 31 also includes a fuse element 36 which provides over-current protection to the positive charge generator 31. The output of the positive charge generator circuit 31 is connected to the positive charge emitter 34 which ionizes (i.e., emits positive ions into) the surrounding air when the positive charge generator circuit 31 is activated. In the current embodiment, the positive charge emitter 34 is located within an enclosed portion of the mail processing system 10.

The negative charge generator circuit 32 receives a high-frequency AC voltage supplied from the secondary windings of by transformer 33 when relay 23 is energized as described above. The negative charge generator 32 includes a number of diodes (D10, D11, . . . Dₙ₊₁) and a number of capacitors (C10, C11, . . . Cₙ₊₁) which form a multiple stage cascade multiplier for rectifying the high-frequency AC voltage into a negative DC voltage. The negative charge generator 32 also includes a fuse element 37 which provides over-current protection to the negative charge generator 32. The output of the negative charge generator circuit 32 is connected to the negative charge emitter 35 which ionizes (i.e., emits negative ions into) the surrounding air when the negative charge generator circuit 32 is activated. In the current embodiment, the negative charge emitter 35 is located within an enclosed portion of the mail processing system 10.

Although a single positive charge emitter 34 and a single negative charge emitter 35 are illustrated in FIG. 5, it should be apparent that multiple positive charge emitters 34 and/or multiple negative charge emitters 35 may be distributed throughout the mail processing system 10 to better neutralize and eliminate electrostatic charge accumulation. Furthermore, it should be apparent that the output of the positive charge generator circuit 31 and/or the output of the negative charge generator circuit 32 may be applied to other devices, for example one or more collection devices which attract particles carrying the detected electrostatic charge (e.g., dust and rubber particles within the mail processing system 10), while remaining within the scope of the present invention.

In an alternative embodiment, the transformer is a higher ratio step-up transformer such as one with a 4 kV output and fewer voltage multiplier stages could be used in the charge generator circuits.

Although described and illustrated in the context of a use within a mail processing system, it should be apparent that the air ionizer 1 may be utilized in any application for which the elimination of static charge is desirable while remaining within the scope of the present invention. While preferred embodiments of the invention have been described and illustrated above, it should be understood that these are exemplary of the invention and are not to be considered as limiting. Additions, deletions, substitutions, and other modifications can be made without departing from the spirit or scope of the present invention. Accordingly, the invention is not to be considered as limited by the foregoing description but is only limited by the scope of the appended claims.

What is claimed is:

1. A method for eliminating an accumulation of electrostatic charge within an electronic device comprising:
detecting an electrostatic charge having a first polarity within said electronic device; and
responsive to said detecting, generating a neutralizing charge having a second polarity opposite of said first polarity within said electronic device.

2. The method of claim 1 further comprising applying said neutralizing charge to an emitter located within said electronic device structured to ionize the air surrounding the emitter.

3. The method of claim 1 further comprising applying said neutralizing charge to a collection device within said electronic device structured to collect one or more particles carrying said electrostatic charge.

4. The method of claim 1 wherein said electronic device is a mail processing system.

5. An air ionizer comprising:
a control circuit structured to detect an electrostatic charge having a first polarity; and
a charge generator circuit structured to generate a neutralizing charge having a second polarity opposite said first polarity in response to said control circuit detecting said electrostatic charge.

6. The air ionizer of claim 5 further comprising a charge emitter structured to emit said neutralizing charge.

7. The air ionizer of claim 5 further comprising a collection device electrically connectable to said charge generator circuit and structured to carry said neutralizing charge.

8. The air ionizer of claim 5 wherein said control circuit comprises:
an antenna electrically structured to produce an input signal in response to detecting at least one of a positive electrostatic charge and a negative electrostatic charge;
a first path structured to produce a first control signal responsive to said input signal; and
a second path structured to produce a second control signal responsive to said input signal;
wherein said first and second control signals cause said charge generator circuit to generate a negative neutralizing charge when said antenna detects a positive electrostatic charge and wherein said first and second control signals cause said charge generator circuit to generate a positive neutralizing charge when said antenna detects a negative electrostatic charge.

9. The air ionizer of claim 5 wherein said charge generator comprises:
a positive charge generator circuit structured to produce a first output signal when said control circuit detects an electrostatic charge having a negative polarity;
a positive charge emitter electrically connectable to said positive charge generator circuit and structured to emit a positive charge in response to said first output signal;
a negative charge generator circuit structure to produce a second output signal when said control circuit detects an electrostatic charge having a positive polarity; and
a negative charge emitter electrically connectable to said negative charge generator circuit and structured to emit a negative charge in response to said second output signal.

10. The air ionizer of claim 9 further comprising a collection device electrically connectable to at least one of said positive charge generator circuit and said negative charge generator circuit, said collection device structured to carry at least one of a positive charge in response to said first output signal and a negative charge in response to said second output signal.

11. The air ionizer of claim 9 wherein said charge generator further comprises a transformer, said transformer supplying a source voltage to said positive charge generator circuit when said control circuit detects an electrostatic charge having a negative polarity and to said negative charge generator circuit when said control circuit detects an electrostatic charge having a positive polarity.

12. The air ionizer of claim 11 wherein said control circuit further comprises:
a first relay structured to electrically connect said transformer and said positive charge generator circuit in response to a first control signal, said first control signal being generated when said control circuit detects an electrostatic charge having a negative polarity; and
a second relay structured to electrically connect said transformer and said negative charge generator circuit in response to a second control signal, said second control signal being generated when said control circuit detects an electrostatic charge having a positive polarity.

13. The air ionizer of claim 9 wherein at least one of said positive charge generator circuit and said negative charge generator circuit is a multiple stage cascade multiplier.

14. A mail processing system comprising:
a housing having a substantially enclosed area;
one or more modules for processing mail pieces supported by said housing; and
an air ionizer comprising:
a control circuit structured to detect an electrostatic charge having a first polarity within said substantially enclosed area; and
a charge generator circuit structured to generate a neutralizing charge having a second polarity opposite said first polarity within said substantially enclosed area in response to said control circuit detecting said electrostatic charge.

15. The mail processing system of claim 14 wherein said air ionizer further comprises a charge emitter structured to emit said neutralizing charge within said substantially enclosed area.

16. The mail processing system of claim 14 wherein said air ionizer further comprises a collection device electrically connectable to said charge generator circuit and structured to carry said neutralizing charge within said substantially enclosed area.

17. The mail processing system of claim 14 wherein said control circuit comprises:
an antenna structured to produce an input signal in response to detecting at least one of a positive electrostatic charge and a negative electrostatic charge within said substantially enclosed area;
a first path structured to produce a first control signal responsive to said input signal; and
a second path structured to produce a second control signal responsive to said input signal;
wherein said first and second control signals cause said charge generator circuit to generate a negative neutralizing charge when said antenna detects a positive electrostatic charge within said substantially enclosed area and wherein said first and second control signals cause said charge generator circuit to generate a positive neutralizing charge when said antenna detects a negative electrostatic charge within said substantially enclosed area.

18. The mail processing system of claim 14 wherein said charge generator comprises:
a positive charge generator circuit structured to produce a first output signal when said control circuit detects an electrostatic charge having a negative polarity within said substantially enclosed area;
a positive charge emitter electrically connectable to said positive charge generator circuit and structured to emit a positive charge within said substantially enclosed area in response to said first output signal;
a negative charge generator circuit structure to produce a second output signal when said control circuit detects an electrostatic charge having a positive polarity within said substantially enclosed area; and
a negative charge emitter electrically connectable to said negative charge generator circuit and structured to emit a negative charge within said substantially enclosed area in response to said second output signal.

19. The mail processing system of claim 18 further comprising a collection device electrically connectable to at least one of said positive charge generator circuit and said negative charge generator circuit, said collection device structured to carry at least one of a positive charge in response to said first output signal and a negative charge in response to said second output signal, said collection device being located within said substantially enclosed area.

20. The mail processing system of claim 18 wherein said charge generator further comprises a transformer, said transformer supplying a source voltage to said positive charge generator circuit when said control circuit detects an electrostatic charge having a negative polarity within said substantially enclosed area and to said negative charge generator circuit when said control circuit detects an electrostatic charge having a positive polarity within said substantially enclosed area.

21. The mail processing system of claim 20 wherein said control circuit further comprises:
a first relay structured to electrically connect said transformer and said positive charge generator circuit in response to a first control signal, said first control signal being generated when said control circuit detects an electrostatic charge having a negative polarity; and
a second relay structured to electrically connect said transformer and said negative charge generator circuit in response to a second control signal, said second control signal being generated when said control circuit detects an electrostatic charge having a positive polarity.

22. The mail processing system of claim 18 wherein at least one of said positive charge generator circuit and said negative charge generator circuit is a multiple stage cascade multiplier.
